(19) United States
(12) Patent Application Publication
(10) Pub. No.: US 2004/0040130 A1
(43) Pub. Date: Mar. 4, 2004

(54) Method and apparatus for casket embellishment

(76) Inventor: Sonya Teague, Mesquite, TX (US)

Correspondence Address: J.F. BRYAN & ASSOCIATES, INC., P.O. BOX 1987, PLANO, TX, 75086, US

(21) Appl. No.: 10/235,383

(22) Filed: Sep. 4, 2002

(51) Int. Cl. A61G 17/00

(52) U.S. Cl. 27/19

(57) ABSTRACT

Apparatus for embellishment of the outer panels of a burial casket has a transparent panel of nominal thickness with an inside surface conforming to an outer panel and an artistic depiction applied to the inside surface. The transparent panel is framed by a border and a retaining gasket applied around the border mounts the artistic depiction to the casket outer panel and seals against the incursion of water therebetween.

### TECHNICAL FIELD

The present invention relates to the construction of burial coffins or caskets and more particularly, to methods and apparatus for customized embellishment thereof.

### BACKGROUND

As a general rule coffins, now more commonly referred to as caskets, are intended to lend dignity and substance to funeral proceedings. There have always been a minority who would defy convention for artistic, memorial or idiosyncratic reasons and casket panel embellishments have been available for these individuals. A provider of such embellishments in 1881, was William F. Taylor, who in his U.S. Pat. No. 246,241 disclosed printed fabric panels designed to cover the plain exterior surfaces of a casket, much in the manner of wall paper. Taylor's printed borders defined the trim lines of each fabric panel, so as to simplify the task of fitting the artistic depiction to the panels of a casket, but the actual application would seem to still have required skill and patience.

More recently, Stewart, U.S. Pat. No. 5,813,099 has disclosed apparatus for attachment of a picture of the deceased to virtually any flat exterior panel of a casket. Stewart also discloses a hard, durable transparent cover for protecting the picture from moisture and impact.

George Foley, Jr. discloses a burial casket having prepared surfaces for receiving drawn or painted images, or even decals. If the elected decoration is to be drawn or painted, the skill and services of a talented artist are required. A funeral home can make such arrangements, but scheduling of the work within the time available and the expense involved must be considered. If the elected decoration is a decal, time and expense problems are much less significant, but the result is simply an unprotected decal. Fant et al, in U.S. Pat. No. 6,233,404 B1, discloses a method for embellishing casket panels, with decals made to extend continuously across curves and moldings. Others teach the use of decorative, or theme panels, inside of the hinged casket cap. All in all, the desire for individually distinctive casket embellishments persists and appears to attract increasing numbers of practitioners. The long felt need, first expressed by William F. Taylor, for a series of interchangeable panel enhancements, is perceived to be redefined to include realistic artwork depicting life interests and/or hobbies of the deceased.

A first object of the present inventions is therefore, to provide method and apparatus for providing artwork in a variety of interchangeable depictions to be applied to the panels of a burial casket. A second object is that these depictions be durable, so as to be unaffected by moisture and time. A third object is that the depictions have the appearance of being integral to the casket and permanent in nature. Other objects are that the depictions be inexpensive to manufacture in production quantities and capable of quick and easy installation by relatively unskilled workmen.

### SUMMARY OF THE INVENTION

The present inventions contemplate improved methods and apparatus for personalized embellishment of the outer panels of burial caskets. These inventions relate to or employ some steps and apparatus well known in the casket construction and embellishment arts and therefore, not the subject of detailed discussion herein.

The present inventions comprise embellishment apparatus suitable for application on flat or curved outer panel casket surfaces. A border, which may be in the form of a plain or ornate molding, provides a decorative frame for the selected exchangeable depiction. The depictions are transparent panels a nominal thickness of one-eighth inch or so, with an artistic rendering of any subject or scene, personally appropriate to the deceased, applied to the inside surface. The perimeter of the insert is sized and shaped to fit closely into the interior opening of the border, so that the borders serve in the manner of a picture frame, giving the depiction added depth and a finished appearance. A retaining gasket is applied around the border interior, at the perimeter of the depiction, both to hold it in place and seal against damaging water leaks. An “O” ring fitted into a groove where it overlaps and bears against the outer edge of the depiction provides these functional attributes in a preferred embodiment of the present inventions.

The design of the borders should be understated, so as to serve as tasteful embellishments, whether with depictions, or not. With matching borders on every panel, the casket has a balanced, finished appearance. Also, by having borders on every panel of a standardized casket, a funeral director can offer several depictions, one or none, as the case may be, and have complete flexibility in placement. The family of the deceased can even have a depiction exchanged for another, as arrangements are finalized.

### BRIEF DESCRIPTION OF THE DRAWINGS

The accompanying drawings are incorporated into the specification to assist in explaining the present inventions. The drawings illustrate preferred and alternative examples of how the inventions can be made and used and are not to be construed as limiting the inventions to only those examples illustrated and described. The various advantages and features of the present inventions will be apparent from a consideration of the drawings in which:

FIG. 1 is a perspective view of a preferred embodiment of a burial casket incorporating the present inventions;

FIG. 2 is a cross-section view of the embodiment of FIG. 1 as seen along plane 2-2 of FIG. 1;

FIGS. 3A and 3B are cross-section views of an alternative apparatus for depiction retaining and sealing; and

FIGS. 4A and 4B are cross-section views of a second alternative apparatus for depiction retaining and sealing.

### DETAILED DESCRIPTION OF THE DRAWINGS

The present inventions are described in the following by referring to drawings of examples of how the inventions can be made and used. In these drawings, reference characters are used throughout the views to indicate like or corresponding parts. The embodiments shown and described herein are exemplary. Many details are well known in the art, and as such are neither shown nor described.

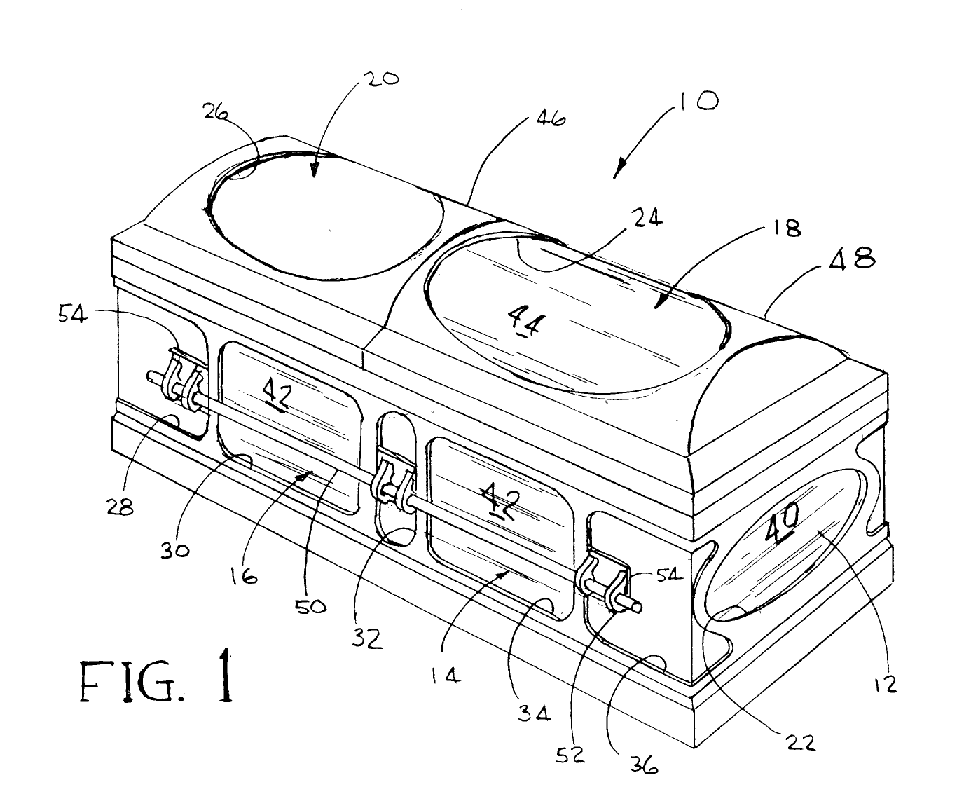

FIG. 1 is a perspective view of a preferred embodiment of a burial casket 10 incorporating the present inventions where it is seen that the exterior panels include both flat and curved areas 12-20, which may be made suitable for the display of artwork. In accordance with the present inventions, the exterior casket panels include design coordinated borders 22-36, which serve as picture frames, giving the artwork added depth and a finished appearance. Certain of the borders are designated to hold depictions 40-44, as is discussed in the following pages. The two side panels opposite panels 14 and 16 are unshown, as is the end panel opposite panel 12, but it is to be understood that everything stated herein concerning panels applies to these unshown panels as well. For the purposes of this disclosure, it is felt that two end depictions 40, four side depictions 42, and one top depiction 44 will afford ample capability for the display of personalized artwork. Thus, only the borders which frame inserts 40-44 are configured for that purpose. It is to be noted that depictions 42 are interchangeable in borders 30 and 34 on the casket side shown and the unshown side. In the same manner, depiction 40 may be installed either in border 22 or, in the unshown border on the opposite end. Thus, it is seen that the borders serve not only to frame depictions 40-44, but also provide cosmetic concealment of retaining gaskets.

Other aspects of casket 10 are familiar to all who have knowledge of the casket arts. Casket head cap 46 and foot cap 48 are hingedly attached in accordance with common practice, although not so shown in the drawings. Handlebars 50 are also mounted to escutcheon plates 54 on each side of casket 10 by means of arms 52 in accordance with common practice. In short, casket 10 of the present inventions is the same as the caskets now well known to funeral homes, except for the exterior embellishments as disclosed herein.

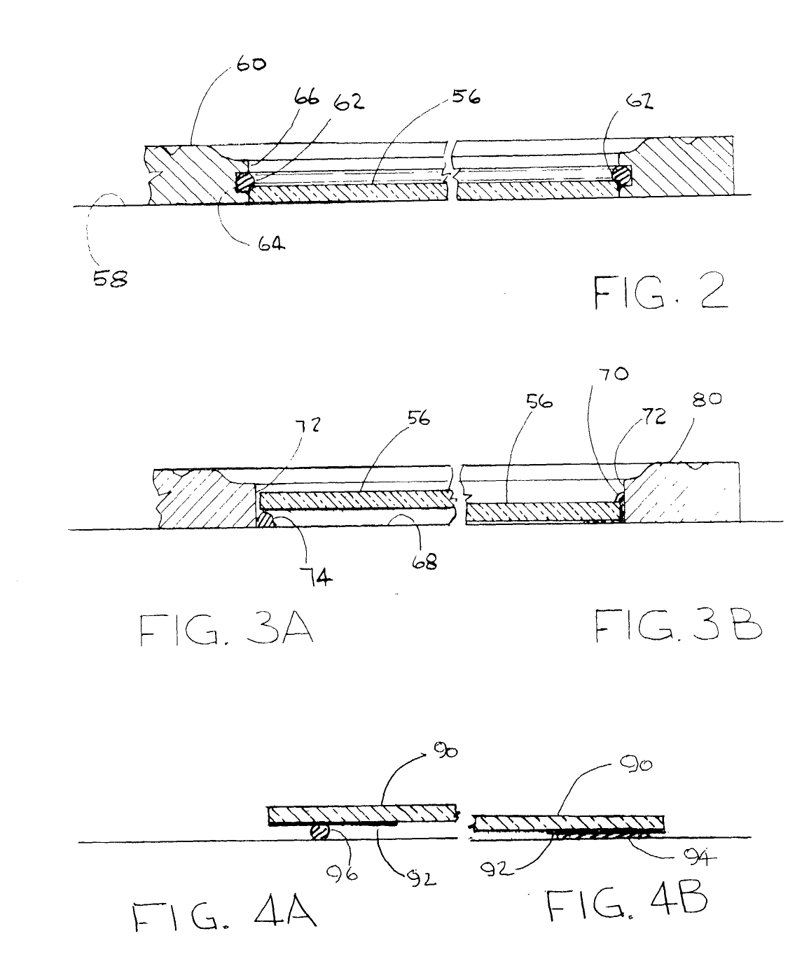

FIG. 2 shows a preferred means for installing a typical depiction 56. Border 60 is shown here as made for application to flat surface 58, but borders and similarly curved depictions can just as well be made to conform to a cylindrically curved surface, such as the exterior of foot cap 48 in FIG. 1 or to a convexly curved surface. Border 60 has a decoratively shaped cross-section that is replicated throughout the casket set. In a preferred embodiment of the inventions, every border potentially designated to receive artwork, as typified by depiction 56, has an interior contour 66 cut to be a close fit to depiction 56. Groove 64 in contour 66 is spaced slightly away from flat surface 58 and is dimensioned to receive elastic “O” ring 62, with a portion of the diameter thereof protruding beyond the surface of contour 66. Thus, “O” ring 62 must be compressed as depiction 56 is pressed into place and springs back out as depiction 56 is fully seated within contour 66. The spacing of groove 64 from flat surface 58 is such that “O” ring 62 overlaps and bears against depiction 56 in its seated condition. In this manner, “O” ring 62 becomes a retainer and a gasket, holding depiction 56 in place and sealing against potential water leakage and consequent damage to the artwork. Thus, it is seen that the borders serve not only to frame depictions 40-44, but also provide cosmetic concealment of the necessary retaining gaskets.

Even if no depiction 56 is installed in a designated molding 60, “O” ring 62 does not detract from the finished appearance, whether it remains in place or not. Borders not designated to receive artwork are simply made without groove 64, but otherwise are identical in appearance.

FIGS. 3A and 3B illustrate how an alternative to “O” ring 62 and groove 64 can be provided by a “formed-in-place” silicon or urethane gasket 70, made by applying a bead of gasket compound 74 around inner contour 72 of border 80, at flat surface 68, as shown in FIG. 3A. It is preferable to leave a short gap in bead 74, so that air can escape as depiction 56 is pressed into place, as shown in FIG. 3B. This gap is then closed and sealed from the outside. In this view, bead 74 is seen to extrude, filling the clearance space between depiction 56 and contour 72, even to overlapping the outer edge of depiction 56. In this manner, depiction 56 is retained and sealed, as effectively as with the preferred “O” ring method. Inasmuch as a small amount of the gasket compound will also be squeezed under depiction 56 and away from border 80, it is preferable to use a clear silicone or urethane compound for gasket 70. In any case, its proximity to border 80 will make its presence unobvious. This formed-in-place gasket method does not allow the ready removal or exchange of depictions 56, but has the advantage of allowing artwork to be installed in undesignated moldings that do not have an “O” ring groove.

FIGS. 4A and 4B show an alternative embodiment wherein depiction 90 effectively includes integral border 92, applied to either the inner or outer surface of depiction 90. Border 92 may be a plain, solid color, or an ornate representation of a picture frame. In either case, border 92 serves to frame the artwork of depiction 90, giving it added depth and a more finished appearance. Depiction 90 may be flat or may be made to conform to a cylindrical or convex surface, so as to be capable of installation on any matching casket panel. Installation is by the formed-in-place gasket method, basically as described for the installation of FIGS. 3A & 3B. A “formed-in-place” silicon or urethane gasket 94, is made by applying a bead of gasket compound 96 around the underside of border 92, where it will be hidden. Again, it is preferable to leave a short gap in bead 96, so that air can escape as depiction 90 is pressed into place, as shown in FIG. 4B. This gap is then closed and sealed from the outside. In this manner, depiction 90 is retained and sealed, as effectively as with the preferred “O” ring method. A small amount of the gasket compound may also be extruded beyond the outer edge of depiction 90. Even though this excess is easily removed with a clean rag and solvent, it is preferable to use a clear silicone or urethane compound for gasket 94. In any case, its proximity to border 92 will make its presence unobvious. This formed-in-place gasket method does not allow the ready removal or exchange of depictions 90, but has the advantage of allowing artwork to be installed on caskets not otherwise configured for the purpose.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of shape, size, and arrangement of the parts within the scope and principles of the inventions. The restrictive description and drawings of the specific examples above do not point out what an infringement of this patent would be, but are to provide at least one explanation of how to use and make the inventions. The limits of the inventions and the bounds of the patent protection are measured by and defined in the following claims.

I claim:

1. Apparatus for embellishment of the outer panels of a burial casket comprising:
a burial casket with at least a portion of one outer panel being suitably contoured for mounting an artwork depiction;
a border with an interior contour of a given shape;
a transparent panel of nominal thickness having an inside surface conformed to the outer panel contour, with a perimeter matching the given shape and fitted into the interior contour;
an artistic depiction applied to the inside surface; and
a retaining gasket applied to the interior contour so as to hold the transparent panel in place and seal against the incursion of water.

2. The apparatus of claim 1 wherein the retaining gasket is an “O” ring that overlaps the transparent panel.

3. The apparatus of claim 1 wherein the retaining gasket is formed-in-place between the transparent panel and the casket outer panel.

4. The apparatus of claim 1 wherein the outer panel and the transparent insert are cylindrically curved.

5. The apparatus of claim 1 wherein the outer panel and the transparent insert are convexly curved.

6. The apparatus of claim 1 wherein the outer panel and the transparent insert are flat.

7. Apparatus for embellishment of the outer panels of a burial casket comprising:
a burial casket with at least a portion of one outer panel being suitably contoured for mounting an artwork depiction;
a transparent panel of nominal thickness, with an inside surface conforming to the outer panel portion;
a border around the transparent panel;
an artistic depiction applied to the inside surface; and
a retaining gasket applied around the border, so as to mount the artistic depiction on the casket outer panel and seal against the incursion of water therebetween.

8. The apparatus of claim 7 wherein the border is applied to the transparent panel.

9. The apparatus of claim 7 wherein the border is applied to the casket outer panel.

10. The apparatus of claim 7 wherein the retaining gasket is formed-in-place between the transparent panel and the outer panel.

11. The apparatus of claim 7 wherein the outer panel and the transparent panel are cylindrically curved.

12. The apparatus of claim 7 wherein the outer panel and the transparent panel are convexly curved.

13. The apparatus of claim 1 wherein the outer panel and the transparent insert are flat.

14. A method for embellishing the outer panels of a burial casket comprising the steps of:
framing a portion of at least one outer panel with a border having an interior opening of a given shape;
providing a transparent panel with an inner surface conformed to the framed panel portion and having a perimeter conforming to the interior opening;
decorating the inner surface with an artistic depiction;
fitting the transparent panel closely within the interior opening, with the artistic depiction on the side against the casket; and
applying a retaining gasket to the interior opening so as to hold the transparent panel in place.

15. A method for embellishing the outer panels of a burial casket comprising the steps of:
providing a transparent panel having an inner surface conformed to at least a portion of an outer panel;
framing the transparent panel with a border;
applying an artistic depiction to the inner surface, within the border;
laying a bead of gasket compound on the inner surface, around the border;
fitting the transparent panel onto the conforming outer panel portion; and
pressing the transparent panel against the conforming outer panel portion to spread the gasket compound, so as to make a formed-in-place gasket.
